(19) United States
(12) Patent Application Publication
(10) Pub. No.: US 2007/0218328 A1
(43) Pub. Date: Sep. 20, 2007

(54) Fuel cell system

(75) Inventor: Yasuhiro Osada, Kariya-shi (JP)

Correspondence Address: OLIFF & BERRIDGE, PLC, P.O. BOX 19928, ALEXANDRIA, VA, 22320, US

(73) Assignee: DENSO CORPORATION, KARIYA-CITY (JP)

(21) Appl. No.: 11/717,747

(22) Filed: Mar. 14, 2007

(30) Foreign Application Priority Data
Mar. 16, 2006 (JP) 2006-072634

(51) Int. Cl. H01M 8/04; H01M 16/00; H01M 10/50

(52) U.S. Cl. 429/22; 429/9; 429/62; 429/26; 429/120

(57) ABSTRACT

The fuel system includes a fuel cell capable of generating electric power to be supplied to electric loads, a storage battery charged by the fuel cell and capable of supplying electric power stored therein to the electric loads, a first gas-supply path through which the oxidizing gas to be supplied to the fuel cell passes, a compressor for compressing the oxidizing gas passing through the first gas-supply path, a second gas-supply path branching from the first gas-supply path, through which the oxidizing gas discharged from the compressor passes toward the storage battery, a flow-switch valve operating to switch a flow direction of the oxidizing gas between a first direction through the first gas-supply path toward the fuel cell and a second direction through the second gas-supply path toward the storage battery, and a control unit controlling a flow direction switching operation of the flow-switch valve.

### CROSS-REFERENCE TO RELATED APPLICATION

This application is related to Japanese Patent Application No. 2006-72634 filed on Mar. 16, 2006, the contents of which are hereby incorporated by reference.

### BACKGROUND OF THE INVENTION

1. Field of the Invention

The present invention relates to a fuel cell system including fuel cells for generating electric energy by electrochemical reaction between hydrogen and oxygen, especially to a fuel cell system having a function of warming up its built-in storage battery serving to supply electric power to a vehicle-driving motor and to accessories of the fuel cell system.

2. Description of Related Art

Such a fuel cell system is configured to bring its accessories into operation by electric power received from its built-in second battery to start the fuel cells thereof. It is common that a nickel-metal-hydride battery or a lithium-ion battery is used as such a built-in second battery. The conventional fuel cell system as described above has a problem in that the accessories thereof cannot deliver required performance in a low temperature environment, because the charge/discharge performance of the nickel-metal-hydride battery and the lithium-ion battery are extremely lowered when the battery temperature falls below zero degrees C.

To cope with this problem, it has been proposed to supply warm air to the inside of a case of the storage battery from a heat pump of a cabin air-conditioning system to warm up the storage battery early on (refer to Japanese Patent Application Laid-open No. 5-262144, for example)

However, in this configuration, air conditioning capacity in a cabin is lowered by the amount of the warm air supplied to the storage battery. Accordingly, it becomes necessary to upsize the air conditioning system, or to increase the output of a refrigerant compressor, which worsens a system efficiency of the entire vehicle.

### SUMMARY OF THE INVENTION

The present invention provides a fuel system comprising:

a fuel cell capable of generating electric power by electrochemical reaction between an oxidizing gas and a reducing gas, and supplying generated electric power to electric loads;

a storage battery electrically connected to the fuel cell so as to be charged by the fuel cell, and capable of supplying electric power stored therein to the electric loads;

a first gas-supply path through which the oxidizing gas to be supplied to the fuel cell passes;

a compressor provided in the first gas-supply path to compress the oxidizing gas passing through the first gas-supply path;

a second gas-supply path branching from the first gas-supply path, through which the oxidizing gas discharged from the compressor passes toward the storage battery;

a flow-switch valve operating to switch a flow direction of the oxidizing gas between a first direction through the first gas-supply path toward the fuel cell and a second direction through the second gas-supply path toward the storage battery; and

a control unit controlling a flow direction switching operation of the flow-switch valve.

According to the invention in which the storage battery is warmed by use of the air that has risen in temperature by being compressed in the compressor, in other words, a surplus energy in the fuel cell system, is utilized to warm the storage battery, it is possible to warm the storage battery without degrading the efficiency of the entire system.

The flow-switch valve may be configured to individually adjust a flow rate of the oxidizing gas flowing in the first direction and the oxidizing gas flowing in the second direction.

The fuel cell system may further comprise a temperature sensor for detecting a temperature of the storage battery, so that the control unit controls the flow-direction switching operation of the flow-switch valve on the basis of the temperature of the storage battery detected by the temperature sensor.

The fuel cell system may further comprise a second temperature sensor for detecting a temperature of the oxidizing gas discharged from the compressor, so that the control unit controls the flow-direction switching operation of the flow-switch valve on the basis of the temperature of the storage battery detected by the first temperature sensor, and the temperature of the oxidizing gas detected by the second temperature sensor.

The fuel cell system may further comprise a heat exchanger provided in the first gas-supply path for cooling the oxidizing gas discharged from the compressor. In this case, the second gas-supply path branches from the first gas-supply path in the upstream of the heat exchanger.

The fuel cell system may further comprise a third gas-supply path through which the oxidizing gas supplied to the storage battery passes to return to the first gas-supply path in the downstream of the heat exchanger.

Other advantages and features of the invention will become apparent from the following description including the drawings and claims.

### BRIEF DESCRIPTION OF THE DRAWINGS

In the accompanying drawings:

FIG. 1 is a diagram showing an overall structure of a fuel cell system according to an embodiment of the invention, which is mounted on an electric vehicle (fuel cell vehicle) that runs on the electric power supplied from this fuel cell system;

FIG. 2 is a diagram explaining signals inputted to and outputted from a control unit included in the fuel cell system shown in FIG. 1; and

FIG. 3 is a flowchart showing flow of a temperature control performed by the control unit shown in FIG. 2.

### PREFERRED EMBODIMENTS OF THE INVENTION

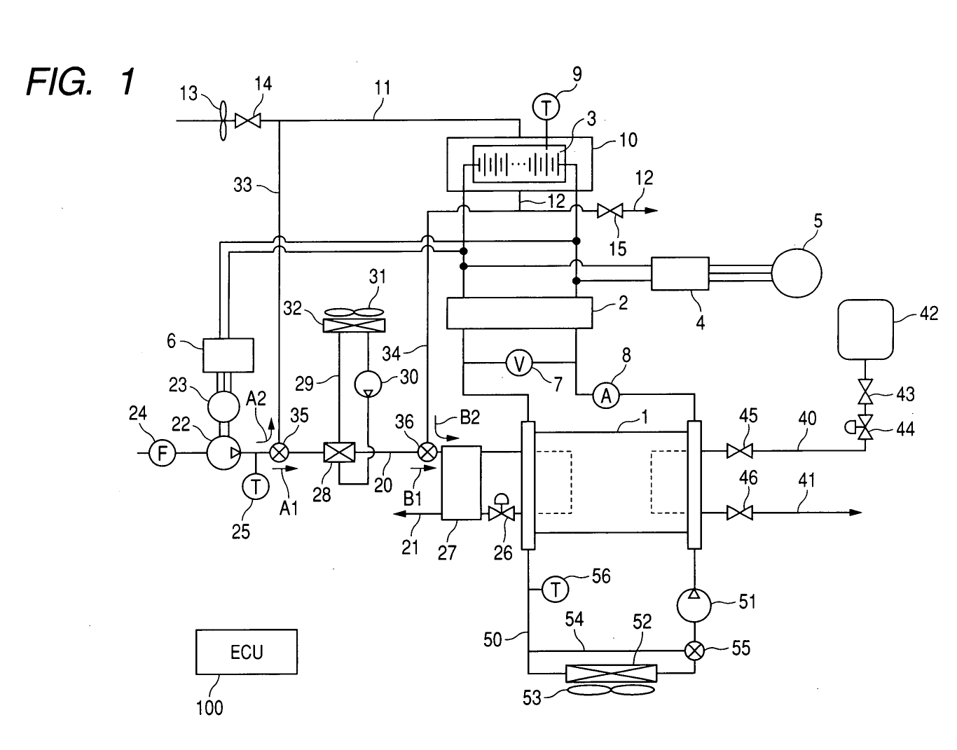

FIG. 1 is a diagram showing an overall structure of a fuel cell system according to an embodiment of the invention, which is mounted on an electric vehicle (fuel cell vehicle) that runs on the electric power supplied from this fuel cell system. As shown in this figure, the fuel cell system includes a fuel cell 1 generating electric power by electrochemical reaction between hydrogen as a reducing gas and oxygen as an oxidizing gas. In this embodiment, as the fuel cell 1, a solid high-molecular type fuel cell constituted by a plurality of laminated unit cells is used.

In the fuel cell 1, there occurs electrochemical reaction between hydrogen and oxygen as represented by the following chemical equations.

Anode (hydrogen electrode): H₂→2H⁺+2e⁻

Cathode (oxygen electrode): 2H⁺+½O₂+2e⁻→H₂O

Total: H₂+½0₂→H₂O

The fuel cell 1 and a storage battery 3 are electrically connected to each other through a DC-DC converter 2 operating to control electric power flow between the fuel cell 1 and the storage battery 3. The DC-DC converter 2 is capable of charging the storage battery 3 with electric power generated by the fuel cell 1, and supplying electric power stored in the secondary cell 3 to the fuel cell 1 and to a travel-use inverter 4 through a stepup/stepdown chopper circuit. That is, the DC-DC converter 2 is capable of transmitting electric power bidirectionally between the fuel cell 1 and the storage battery 3 irrespective of difference in voltage between them.

The storage battery 3, which operates to store electric power supplied from the fuel cell 1, and to supply the stored electric power to various electric loads, may be a nickel-metal-hydride battery or a lithium ion battery.

The travel-use inverter 4, which is connected between the DC-DC converter 2 and the storage battery 3, is supplied with electric power from the fuel cell 1 or the storage battery 3 through the DC-DC converter 2. The travel-use inverter 4 may be connected between the fuel cell 1 and the DC-DC converter 2.

The travel-use inverter 4 is for driving a travel-use motor 5, and for causing the travel-use motor 5 to regenerate electric power. The travel-use inverter 4 is a three-phase inverter for supplying a three-phase AC power to the travel-use motor 5 so that the travel-use motor 5 rotates driving the fuel cell vehicle to travel.

The storage battery 3 can accumulate a surplus of electric power generated by the fuel cell 1, and also accumulate electric power regenerated through a regeneration braking operation. According to this embodiment in which the storage battery 3 is configured to be able to supply electric power to the travel-use inverter 4, it is possible for the travel-use motor 5 to output a required power when the fuel cell vehicle needs a large drive power, for example, when the fuel cell vehicle is under hard acceleration, because the travel-use inverter 4 can be supplied with electric power not only from the fuel cell 1 but also from the storage battery 3.

A compressor inverter 6 for driving a compressor motor 23 is connected between the DC-DC converter 2 and the storage battery 3. Although not shown in FIG. 1, the fuel cell system includes a water pump inverter connected between the DC-DC 2 converter and the storage battery 3 for driving water pumps 30, 51. The fuel cell system also includes a voltage sensor 7 for detecting a terminal voltage of the fuel cell 1, and a current sensor 8 for detecting an output current of the fuel cell 1. The storage battery 3 is provided with a temperature sensor 9 for detecting a temperature of the storage battery 3. The compressor motor 23 is supplied with electric power from the fuel cell 1 normally. However, the compressor motor 23 is supplied with electric power from both the fuel cell 1 and the storage battery 3 when the fuel cell 1 is started.

The storage battery 3 is housed in a storage battery case 10 with an appropriate clearance between the outer periphery of the storage battery 3 and the inner periphery of the storage battery case 10. A temperature-adjusting air supply path 11 and a temperature-adjusting air discharge path 12 are connected to the storage battery case 10 for introducing and discharging temperature-adjusting air to and from the storage battery case 10. The temperature-adjusting air supply path 11 is provided therein a fan 13 for forcibly introducing the outside air to the inside of the storage battery case 10. When the temperature of the storage battery 3 rises, and it becomes necessary to cool the storage battery 3, the outside air is introduced to the inside of the storage battery case 10 through the temperature-adjusting air supply path 11. The introduction of the outside air into the storage battery case 10 is performed by activating the fan 13, or it is performed by natural air convection without activating the fan 13. The temperature-adjusting air supply path 11 is provided with a shut valve 14 in the downstream of the fan 13. The temperature-adjusting air discharge path 12 is provided with a shut valve 15.

The fuel cell system also includes an air supply path 20 through which an oxygen gas (air) to be supplied to the oxygen electrode of the fuel cell 1 passes, and an air discharge path 21 through which a gas discharged from the oxygen electrode passes. The air supply path 20 is provided with an air supply device 22. In this embodiment, as the air supply device 22, an air compressor for adiabaticly compressing air is used. Accordingly, the temperature of the air discharged from the air supply device 22 is higher than that of the air introduced to the air supply device 22. The air supply device 22 is mechanically connected to the compressor motor 23. The rotational speed of the compressor motor 23 is controlled by the compressor inverter 6 operating to supply electric power to the compressor motor 23.

The air supply path 20 is provided with an air flow sensor 24 in the upstream of the air supply device 22 for detecting a flow rate of the air supplied to the fuel cell 1. The air supply path 20 is also provided with a temperature sensor 25 in the upstream of the air supply device 22 for detecting a temperature of the air discharged from the air supply device 22. The air discharge path 21 is provided with a pressure regulating device 26 for regulating the air discharge pressure (the back pressure of the fuel cell 1) at a desired value.

To drive the electrochemical reaction in the fuel cell 1, solid polymer membranes included in the fuel cell 1 have to be kept in a wet condition. Accordingly, the air supply path 20 is provided with a humidifier device 27 in the downstream of the air supply device 22 for humidifying the air supplied to the fuel cell 1. The humidifier device 27, which is configured to perform moisture transference by use of a high polymer fiber, humidifies the air discharged from the air supply device 22 by the moisture contained in the wet air discharged from the fuel cell 1. Since the high polymer fiber included in the humidifier device 27 is broken if its temperature exceeds a certain maximum allowable limit temperature, like electrolyte membrane included in the fuel cell 1, it is necessary to keep the air introduced to the humidifier device 27 at a low temperature.

To this end, the air supply path 20 is provided with an intercooler 28 in the downstream of the air supply device 22 and the upstream of the humidifier device 27 for cooling the air discharged from the air supply device 22. The intercooler 28 is a water-cooled heat exchanger performing heat exchange between the air flowing through the air supply path 20 and the cooling water circulating in a cooling water circulation channel 29. The cooling water circulation channel 29 is provided with the water pump 30 for circulating the cooling water, and a radiator 32 including a fan 31.

The air supply path 20 is provided with a first air bypass path 33 branching from the air supply path 20 through a first flow-switch valve 35 disposed in the downstream of the air supply device 22 and upstream of the intercooler 28. The first air bypass path 33 connects a portion of the air supply path 20 located between the air supply device 22 and the intercooler 28 to a portion of the temperature-adjusting air supply path 11 located downstream of the shut valve 14. Accordingly, the air discharged from the air supply device 22 can be supplied to the storage battery 3 through the first air bypass path 33 and the temperature-adjusting air supply path 11.

The air supply path 20 is also provided with a second air bypass path 34 branching from the air supply path 20 through a second flow-switch valve 36 disposed in the downstream of the intercooler 28 and upstream of the fuel cell 1. The second air bypass path 34 connects a portion of the air supply path 20 located between the intercooler 28 and the fuel cell 1 to the temperature-adjusting air discharge path 12. Accordingly, the air discharged from the storage battery case 10 can be supplied to the fuel cell 1 through the temperature-adjusting air discharge path 12, the second air bypass path 34, and the air supply path 20.

The first flow-switch valve 35 is capable of switching the flow direction of the air discharged from the air supply device 22 between the A1 direction and the A2 direction shown in FIG. 1. The second flow-switch valve 36 is capable of switching the flow direction of the air supplied to the fuel cell 1 between the B1direction and the B2 direction shown in FIG. 1.

When the fuel cell 1 is operating normally, the first flow-switch valve 35 switches the flow direction to the A1 direction, and the second flow-switch valve 36 switches the flow direction to the B1 direction. If the temperature of the storage battery 3 is low, and it is necessary to warm the storage battery 3, the shut valves 14, 15 are closed, and the first flow-switch valve 35 switches the flow direction to the A2 direction, in order that the air discharged from the air supply device 22 is supplied to the inside of the storage battery case 10 to warm the storage battery 3. At this time, the second flow-switch valve 36 switches the flow direction to the B2 direction, so that the air used to warm the storage battery 3 can be supplied to the fuel cell 1.

The fuel cell system further includes a hydrogen supply path 40 through which a hydrogen gas to be supplied to the hydrogen electrode of the fuel cell 1 passes, and a hydrogen discharge path 41 through which a gas discharged from the hydrogen electrode of the fuel cell 1 passes. The hydrogen supply path 40 is provided with a hydrogen supply device 42 in the uppermost stream portion thereof. In this embodiment, a hydrogen tank containing high-pressure hydrogen is used as the hydrogen supply device 42.

The hydrogen supply path 40 is also provided with a first shut valve 43, a pressure regulating device 44, and a second shut valve 45 in the direction from upstream to downstream. To supply hydrogen to the fuel cell 1, the first and the second shut valves 43, 45 are opened, and the pressure regulating device 44 is put into operation so that the hydrogen is kept at a desired pressure. To stop the fuel cell vehicle, the first and the second shut valves 43, 45 are closed for safety.

The hydrogen discharge path 41 is provided with a third shut valve 46. By opening the third shut valve 46 as needed, it is possible to discharge unreacted hydrogen gas, vapor (or water), and impurities such as nitrogen, and oxygen that have moved to the hydrogen electrode side from the oxygen electrode side through the electrolyte membrane.

While the electrochemical reaction is in progress in the fuel cell 1 to generate electric power, the fuel cell 1 generates heat. The fuel cell 1 has to be kept at a constant temperature (about 70 degrees C., for example) during its operation to assure power generation efficiency. In addition, since the electrolyte membrane included in the fuel cell 1 is broken if its temperature exceeds a certain maximum allowable limit temperature, the fuel cell 1 has to be kept below a certain temperature. Accordingly, the fuel cell system is provided with a cooling system for cooling the fuel cell 1. This cooling system includes a cooling water channel 50, a water pump 51 for circulating the cooling water in the cooling water channel 50, and a radiator 52 including a fan 53.

The water pump 51 is mechanically connected to a water pump motor (not shown). When the water pump motor is driven to rotate the water pump 51, the cooling water is circulated in the cooling water channel 50 to be supplied to the fuel cell 1. The rotational speed of the water pump motor is controlled by a water pump inverter (not shown) operating to supply electric power to the water pump motor.

The cooling water channel 50 is provided with a bypass channel 54 for causing the cooling water to bypass the radiator 52. A flow-switch valve 55 is provided in a confluence point between the cooling water channel 50 and the bypass channel 54. The flow-switch valve 55 may be an electric-powered control valve, or a mechanical control valve using a thermostat, for example.

The cooling water channel 50 is provided with a temperature sensor 56 in the vicinity of a cooling water outlet of the fuel cell 1 for detecting a temperature of the cooling water discharged from the fuel cell 1. Detecting the temperature of the cooling water by use of the temperature sensor 56 makes it possible to detect indirectly the temperature T_{FC} of the fuel cell 1. Alternatively, the temperature sensor 56 may be mounted directly to the fuel cell 1 in order to directly measure the temperature T_{FC} of the fuel cell 1.

The heat generated by the fuel cell 1 is discharged from the fuel cell system from the radiator 52 through the cooling water. The cooling system having the configuration described above is capable of performing cooling water flow control by use of the water pump 51, cooling air flow control by use of the fan 53, and bypass flow control by use of the flow-switch valve 55 in order to control the cooling rate of the fuel cell 1.

The fuel cell system further includes an electronic control unit (ECU) 100. The control unit 100, which is constituted by a CPU, a ROM, a RAM, and I/O, performs various computations in accordance with programs stored in the ROM.

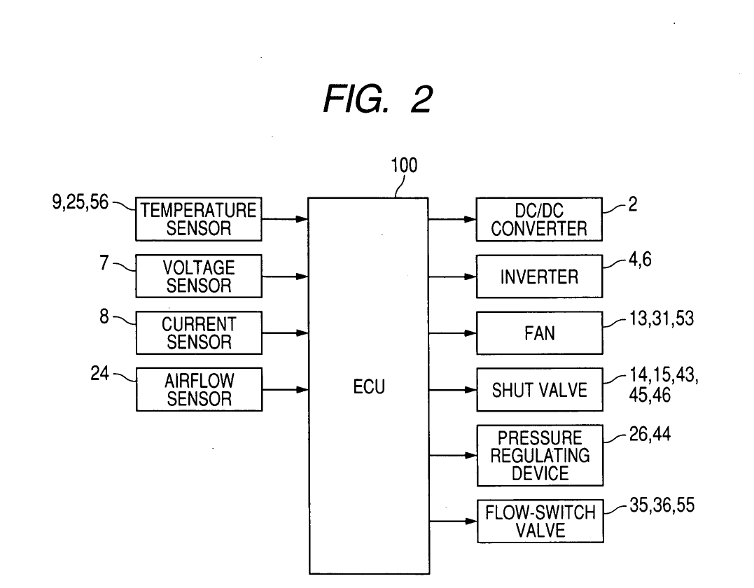

FIG. 2 is a diagram explaining signals inputted to and outputted from the control unit 100. The control unit 100 receives required-power signals from various electric loads, temperature signals from the temperature sensors 9, 25, 56, a voltage signal from the voltage sensor 7, a current signal from the current sensor 8, an airflow rate signal from the airflow sensor 24, etc. The control unit 100 outputs various control signals to the DC-DC converter 2, inverters 4, 6, fans 13, 31, 53, the shut valves 14, 15, 43, 45, 46, pressure regulating device 26, 44, flow-switch valves 35, 36, 55, etc.

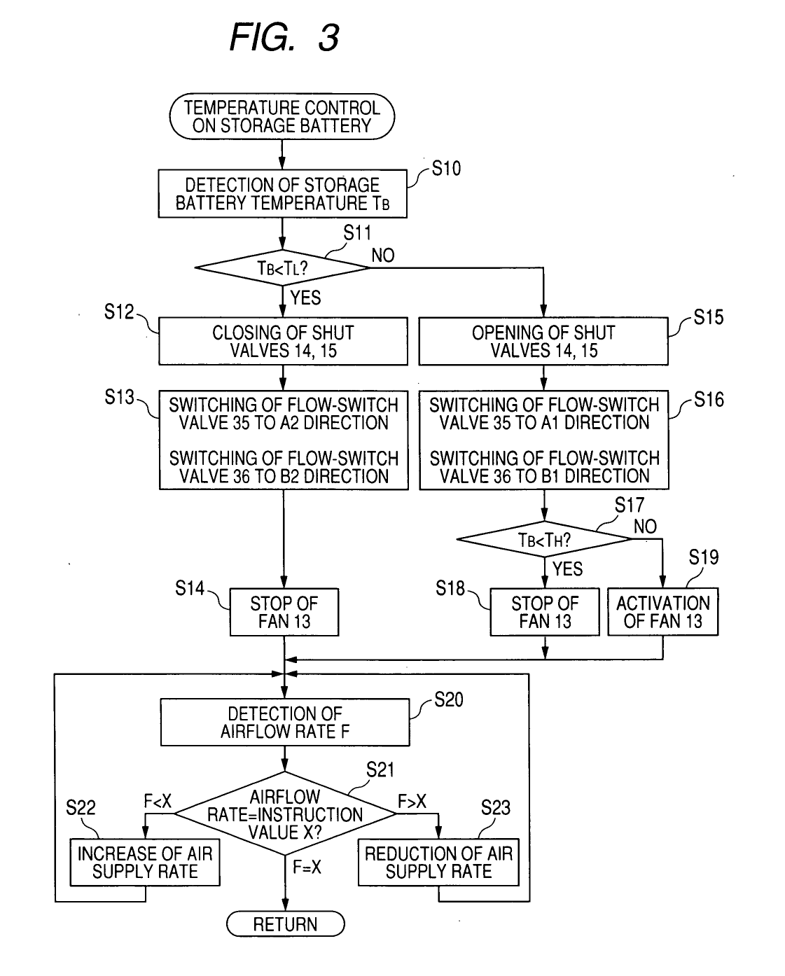

Next, the temperature control on the secondary 3 battery is explained with reference to FIG. 3 which is a flowchart showing flow of this temperature control performed by the control unit 100 in accordance with a specific program stored in its ROM. This temperature control is performed at regular intervals.

Here, it is assumed that, before the temperature control on the second battery 3 is started, the accessories of the fuel cell 1 including the compressor motor 23 starts to be activated, air and hydrogen are started to be supplied to the fuel cell 1, and the fuel cell 1 starts to generate electric power. After the fuel cell 1 starts its power generating operation, since the fuel cell 1 is warmed faster than the storage battery 3, the accessories are supplied with electric power from the fuel cell 1 as explained below.

This temperature control begins by detecting the temperature T_{B} of the storage battery 3 by use of the temperature sensor 9 at step S10. At next step S11, it is judged at step S 11 whether or not the temperature T_{B} of the storage battery 3 is lower than a reference low-limit temperature T_{L}. The reference low-limit temperature T_{L} is set at such a value that the charge/discharge performance of the storage battery 3 is estimated to start to degrade when its temperature falls below this value. In this embodiment, the reference low-limit temperature T_{L} is set to 0 degree C.

If it is judged that the temperature T_{B} of the storage battery 3 is lower than the reference low-limit temperature T_{L} (YES at step S1), since it means that the storage battery 3 needs to be warmed, the shut valves 14, 15 are closed at step S12, the first flow-switch valve 35 is switched to the A2 direction and second flow-switch valve 36 is switched to the B2 direction at step S13, and then at step S14, the fan 13 is stopped.

As a consequence, the route of the warm air discharged from the air supply device 22 becomes as follow.

The air supply path 20→the first air bypass path 33→the temperature-adjusting air supply path 11→the storage battery case 10→the temperature-adjusting air discharge path 12→the second air bypass path 34→the air supply path 20.

The storage battery 3 is warmed by the warm air introduced into the storage battery case 10. The warm air that has been used to warm the storage battery 3 in the storage battery case 10 is supplied to the fuel cell 1 through the temperature-adjusting air discharge path 12, the second air bypass path 34, and the air supply path 20, so that it is used to generate electric power.

On the other hand, if it is judged that the temperature T_{B} of the storage battery 3 is not lower than the reference low-limit temperature T_{L} (NO at step S11), since it means that the storage battery 3 does not need to be warmed, the shut valves 14, 15 are opened at step S15, and then at step S16, the first flow-switch valve 35 is switched to the A1 direction and the second flow-switch valve 36 is switched to the B1 direction.

As a consequence, the route of the warm air discharged from the air supply device 22 becomes as follow.

The air supply path 20→the intercooler 28→the air supply path 20.

The warm air discharged from the air supply device 22 is supplied to the fuel cell 1 to be used for generating electric power after being cooled by the intercooler 28. At this time, the route of the air supplied to the inside of the storage battery case 10 becomes as follows.

The outside→the temperature-adjusting air supply path 11→the storage battery case 10→the temperature-adjusting air discharge path 12→the outside

After step S16, it is judged at step S17 whether or not the temperature T_{B} of the storage battery 3 is lower than a reference high-limit temperature T_{H}. The reference high-limit temperature T_{H} is set at such a value that the charge/discharge performance of the storage battery 3 is estimated to start to degrade when its temperature rises above this value. If it is judged that the temperature T_{B} of the storage battery 3 is lower than the reference high-limit temperature T_{H} (YES: step S17), since it means that the temperature T_{B} of the storage battery 3 is between the reference low-limit temperature T_{L} and the reference high-limit temperature T_{H}, the fan 13 is stopped at step S18. As a consequence, the outside air is introduced into the inside of the storage battery case 10 by natural air convection. On the other hand, if it is judged that the temperature T_{B} of the storage battery 3 is not lower than the reference high-limit temperature T_{H} (NO: step S17), since it means that the storage battery 3 needs to be cooled, the fan 13 is activated at step S19. As a consequence, the outside air is forcibly introduced into the inside of the storage battery case 10 by the fan 13.

Incidentally, when the route of the air discharged from the air supply device 22 is switched, the air supply rate of the air supply device 22 can be changed due to change of pressure loss. For example, the air supply rate of the air supply device 22 when it supplies the air to the fuel cell 1 by way of the storage battery case 10 (step S12, step S13) is low due to increase of pressure loss compared to when it supplies the air directly to the fuel cell 1. Accordingly, a process for adjusting the air supply rate of the air supply device 22 is performed at step S20 and later steps as explained below.

The airflow rate F is detected by the airflow sensor 24 at step S20. At following step S21, a comparison is made between the detected airflow rate F and an instruction value X. The instruction value X is set at a value necessary for the fuel cell 1 to generate a sum of electric powers required by various loads such as the inverters 4, 6. At step S21, the detected airflow rate F may be judged as equal to the instruction value X, if the detected airflow rate F is in a range of X±α, α being a predetermined tolerance.

If it is judged that the detected airflow rate F is smaller than the instruction value X at step S21, the rotational speed of the compressor motor 23 is increased at step S22 to increase the air supply rate of the air supply device 22. On the other hand, if it is judged that the detected airflow rate F is larger than the instruction value X at step S21, the rotational speed of the compressor motor 23 is reduced at step S23 to reduce the air supply rate of the air supply device 22. If it is judged that the detected airflow rate F is equal to the instruction value X at step S21, this temperature control on the storage battery 3 is terminated.

As explained above, in this embodiment, the storage battery 3 is warmed by use of the air that has risen in temperature by being compressed in the air supply device 22. In other words, a surplus energy in the fuel cell system, is utilized to warm the storage battery 3. This makes it possible to warm the storage battery 3 without degrading the efficiency of the entire system.

It should be noted that since the first air bypass path 33 branches from the air supply path 20 in the upstream of the intercooler 28, the storage battery 3 can be supplied with the air before cooled by the intercooler 28.

It should be noted that various modifications can be made to the above described embodiment as set forth below. In the above described embodiment, the first flow-switch valve 35 is provided at the branch point between the air supply path 20 and the first air bypass path 33, and the second flow-switch valve 36 is provided at the branch point between the air supply path 20 and the second air bypass path 34. However, the first flow-switch valve 35 may be provided at the branch point between the temperature-adjusting air supply path 11 and the first air bypass path 33, and second flow-switch valve 36 may be provided at the branch point between the temperature-adjusting air discharge path 12 and the second air bypass path 34.

In the above described embodiment, the first flow-switch valve 35 is used to switch the route of the air discharged from the air supply device 22 between the A1 direction and the A2 direction. However, instead of the first flow-switch valve 35, a flow rate adjusting valve capable of individually adjusting a flow rate of the air flowing in the A1 direction (toward the fuel cell 1) and a flow rate of the air flowing in the A2 direction (toward the storage battery 3) may be used, so that it becomes possible to adjust the supply rate of the warm air being discharged from the air supply device 22 toward the storage battery 3 depending on the temperature T_{B} of the storage battery 3. The use of such a flow rate adjusting valve makes it possible to reduce electric consumption of the air supply device 22, because as the temperature T_{B} of the storage battery 3 increases, the flow rate of the air flowing in the A2 direction (toward the storage battery 3) is reduced, and the flow rate of the air flowing in the A1 direction (toward the fuel cell) is increased, causing the pressure loss to decrease.

In the above described embodiment, the determination as to whether or not the air discharged from the air supply device 22 should be introduced into the inside of the storage battery case 10 is made on the basis of only the temperature T_{B} of the storage battery 3. However, this determination may be made on the basis of the temperature T_{A} of the air discharged from the air supply device 22 detected by the temperature sensor 25 and the temperature T_{B} Of the storage battery 3. In this case, the air discharged from the air supply device 22 is introduced into the inside of the storage battery case 10 when the temperature T_{B} of the storage battery 3 is lower than the reference low-limit temperature T_{L}, and the temperature T_{A} of the air discharged from the air supply device 22 is higher than a certain reference temperature. This reference temperature is set at such a value that the air discharged from the air supply device 22 can warm the storage battery 3. This makes it possible to prevent the air discharged from the air supply device 22 from being introduced into the inside of the storage battery case 10 when it is not sufficiently warm.

The above explained preferred embodiments are exemplary of the invention of the present application which is described solely by the claims appended below. It should be understood that modifications of the preferred embodiments may be made as would occur to one of skill in the art.

What is claimed is:

1. A fuel system comprising:
a fuel cell capable of generating electric power by electrochemical reaction between an oxidizing gas and a reducing gas, and supplying generated electric power to electric loads;
a storage battery electrically connected to said fuel cell so as to be charged by said fuel cell, and capable of supplying electric power stored therein to said electric loads;
a first gas-supply path through which said oxidizing gas to be supplied to said fuel cell passes;
a compressor provided in said first gas-supply path to compress said oxidizing gas passing through said first gas-supply path;
a second gas-supply path branching from said first gas-supply path, through which said oxidizing gas discharged from said compressor passes toward said storage battery;
a flow-switch valve operating to switch a flow direction of said oxidizing gas between a first direction through said first gas-supply path toward said fuel cell and a second direction through said second gas-supply path toward said storage battery; and
a control unit controlling a flow direction switching operation of said flow-switch valve.

2. The fuel cell system according to claim 1, wherein said flow-switch valve is configured to individually adjust a flow rate of said oxidizing gas flowing in said first direction and said oxidizing gas flowing in said second direction.

3. The fuel cell system according to claim 1, further comprising a temperature sensor for detecting a temperature of said storage battery, said control unit controlling said flow-direction switching operation of said flow-switch valve on the basis of said temperature of said storage battery detected by said temperature sensor.

4. The fuel cell system according to claim 2, further comprising a temperature sensor for detecting a temperature of said storage battery, said control unit controlling said flow-direction switching operation of said flow-switch valve on the basis of said temperature of said storage battery detected by said temperature sensor.

5. The fuel cell system according to claim 1, further comprising a first temperature sensor for detecting a temperature of said storage battery, and a second temperature sensor for detecting a temperature of said oxidizing gas discharged from said compressor, said control unit controlling said flow-direction switching operation of said flow-switch valve on the basis of said temperature of said storage battery detected by said first temperature sensor, and said temperature of said oxidizing gas detected by said second temperature sensor.

6. The fuel cell system according to claim 2, further comprising a first temperature sensor for detecting a temperature of said storage battery, and a second temperature sensor for detecting a temperature of said oxidizing gas discharged from said compressor, said control unit controlling said flow-direction switching operation of said flow-switch valve on the basis of said temperature of said storage battery detected by said first temperature sensor, and said temperature of said oxidizing gas detected by said second temperature sensor.

7. The fuel cell system according to claim 1, further comprising a heat exchanger provided in said first gas-supply path for cooling said oxidizing gas discharged from said compressor, said second gas-supply path branching from said first gas-supply path in the upstream of said heat exchanger.

8. The fuel cell system according to claim 7, further comprising a third gas-supply path through which said oxidizing gas supplied to said storage battery passes to return to said first gas-supply path in the downstream of said heat exchanger.
